(19) United States
(12) Patent Application Publication
(10) Pub. No.: US 2014/0224725 A1
(43) Pub. Date: Aug. 14, 2014

(54) COLD INFUSION DEVICE FOR WATER BOTTLES

(71) Applicant: Tea Spot, Inc., (US)

(72) Inventors: Maria Uspenski, Boulder, CO (US); Alexis Uspenski, Rock Creek, OH (US); Robert Schilling, Olmsted Township, OH (US)

(73) Assignee: TEA SPOT, INC., Boulder, CO (US)

(21) Appl. No.: 13/763,424

(22) Filed: Feb. 8, 2013

(51) Int. Cl. A47J 31/00

(52) U.S. Cl. CPC A47J 31/005
USPC 210/444

(57) ABSTRACT

A steeping device for use on water bottles with a threaded neck or mouth is disclosed. The steeping device includes cap with a female coupler that cooperates with a reversible adapter ring that fits within the female coupler. The adapter ring has an internal divider wall with aperture with teeth along the perimeter of the aperture. The aperture accepts a filter element that has a flange with least one rib that cooperates with the teeth of the adapter ring. The arrangement allows the reversible coupler to be threaded into the female coupler in either direction and capture the flange of the filter between the cap and the internal divider wall while adapter ring engages the threaded neck or mouth of the bottle.

### BACKGROUND OF THE INVENTION

(a) Field of the Invention

This application relates to a device or system for using bottled water or water bottle containers for making infusions of loose-leaf tea or other botanicals. More particularly, but not by way of limitation, to a cap, thread ring, and filter element that accommodate a large variety of threaded bottles for the purpose of brewing and dispensing teas with the bottles.

(b) Discussion of Known Art

The need for filtering teas or similar beverages made from infusions of coffee, herbs, or teas has been recognized through much of human history. This is because the creation of beverages by steeping and thus dissolving flavorants and other soluble substance into liquids has historically been a highly favored manner of adding to the taste and enjoyment of water and other beverages.

Typically, the flavoring of a drink with a material such as tea is done by placing the tea into a permeable container, and then inserting the container into water or other liquid that is to be flavored. Alternatively, loose-leaf teas are often placed into a tea pot and allowed to steep. Then, the tea is poured from the container through a filter that separates the loose tea leaves from the liquid.

More recently, bottled water has become very popular. Unflavored water is sold in plastic bottles that hold about 500 ml of water. These plastic bottles are typically made of very thin plastic, which reduces the amount of plastic waste. The use of these bottles works well for holding only water, for water is typically not carbonated, as are sodas, and thus allows for the use of very thin-walled plastic bottles.

Bottled water is also perceived as being healthier for the consumer than soda drinks, but the down side to the drinking of simply water as compared to soda drinks or other beverages is that people become bored with bottled water, which can be argued as always being the same flavor-less drink. Accordingly, there remains a need for a convenient manner of adding a desired flavor to bottled water, and thus adding health benefits from the infusion of vitamins, minerals and polyphenol antioxidants, and variety in flavors while preserving the convenience of a water bottle. More particularly, there remains a need for a device that can be used for infusing teas and similar herbs or loose flavorants in thin-walled commercial water bottles. This steeping must be done at temperatures that do not affect the rigidity or strength of the water bottle.

A problem associated with creating an infusion device that can be used with thin-walled water bottles is that not all manufacturers use the same size mouth in their water bottles, and not all manufacturers use the same threads on the screw-on caps of water bottles. A commonly used size is the 28 mm Standard Screw Closure, however other sizes of bottlenecks or mouths are also found in the industry. The caps are often equipped with what is known as a “sports cap”, which uses a spout with a telescopically mounted nipple and stopper mechanism that allows the user to open the spout by extending the nipple away from the stopper, and then closing the spout by pushing the nipple back against the stopper.

Therefore, a review of known devices reveals that there remains a need for a simple device that allows a user to steep teas and other loose flavorants in water bottles, while maintaining the convenience of the sports cap type closure used with water bottles.

Still further, there remains a need for a steeping device that can accommodate more than one size of threaded bottle mouth, without requiring that the user carry adapters separately from the steeping device.

### SUMMARY

It has been discovered that providing a steeping device that can be used to engage the threaded neck of various bottles with a threaded neck can solve the problems left unanswered by known art, and a preferred example of the steeping device includes:

A cap with a female coupler having a threaded concave section with an inlet and top portion, the top portion including a wall that extends across the top portion and includes a hole or aperture that leads to a telescopic valve;

A reversible adapter ring that fits within the female coupler. The adapter ring includes an external surface with external helical threads that mate with the internal threads of the female coupler of the cap, the reversible adapter ring also having:
A first end with a first internal surface of a first diameter, the first internal surface including a first set of internal threads of a first pitch; and
A second end having a second internal surface having a second set of internal threads of a second pitch, the first internal surface and the second internal surface extending along an axis, and the first internal surface being separated from the second internal surface by an internal divider wall having an aperture that extends the first internal surface being separated from the second internal surface, the aperture of the internal divider wall having an internal perimeter with a plurality of internal retraining teeth extending from the central aperture; and

The aperture of the internal divider wall of the central aperture reversible adapter ring accepting a filter element there through, the filter element having an inlet with an inlet flange and a mesh section extending from the inlet flange, the inlet flange having at least one rib positioned between the inlet flange and the mesh section, the rib being adapted for engaging the teeth of the adapter ring, so that the reversible coupler can be threaded into the female coupler in either direction and capture the inlet flange between the top wall of the female section and the internal divider wall, so that the rib engages the teeth on the internal divider wall to allow use of the external helical threads that mate with the internal threads of the female coupler of the cap to compress the flange against the cap while allowing the internal threads of the first end or the second end of the reversible adapter ring to engage the threaded neck of the bottle.

It should also be understood that while the above and other advantages and results of the present invention will become apparent to those skilled in the art from the following detailed description and accompanying drawings, showing the contemplated novel construction, combinations and elements as herein described, and more particularly defined by the appended claims, it should be clearly understood that changes in the precise embodiments of the herein disclosed invention are meant to be included within the scope of the claims, except insofar as they may be precluded by the prior art.

### DRAWINGS

The accompanying drawings illustrate preferred embodiments of the present invention according to the best mode presently devised for making and using the instant invention, and in which:

FIG. 1 illustrates the disclosed invention while in use for steeping tea on a water bottle.

FIG. 2 is an exploded view of the main components of the disclosed invention.

FIG. 2A is a view looking up at the disclosed invention while installed on a water bottle.

FIG. 2B is a side view of an example of popular style of thread used on the neck of a thin-walled water bottle, the neck including a pair of parallel threads with a wide pitch.

FIG. 3 illustrates the sports cap and the reversible adapter ring used with the disclosed invention.

FIG. 4 is a perspective view of the reversible adapter ring used with the disclosed invention.

FIG. 5 is a perspective view of the steeping or filter portion used with the disclosed invention.

FIG. 6 is a detailed view of the reversible adapter ring and the internal divider wall and retaining mechanism of the reversible adapter ring.

FIG. 7 is a detailed view of the reversible adapter ring and the internal divider and retaining mechanism of the disclosed invention.

FIG. 8 is a detailed view of the steeping portion used with the disclosed invention, and further illustrates the teeth that are used to cooperate with the retaining mechanism found in the internal divider wall of the reversible adapter ring.

### DETAILED DESCRIPTION OF PREFERRED EXEMPLAR EMBODIMENTS

While the invention will be described and disclosed here in connection with certain preferred embodiments, the description is not intended to limit the invention to the specific embodiments shown and described here, but rather the invention is intended to cover all alternative embodiments and modifications that fall within the spirit and scope of the invention as defined by the claims included herein as well as any equivalents of the disclosed and claimed invention.

Turning now to FIG. 1 where a filter and cap 10 for use on thin-walled water bottles 12. The filter and cap 10 are designed for steeping teas or other beverages made from infusing botanicals in water. Accordingly, FIG. 1 shows the filter and cap 10 mounted on a thin-walled water bottle 12 after tea 14 has been placed in the water 16 in the bottle 12. Accordingly, the preferred method of use of the disclosed invention is to place the tea or other botanicals into the bottle 12, and then use the filter and cap 10 to filter the water that has been infused with tea, to prevent the tea leaves from passing through the filter and cap 10 into the user's mouth, In other words, the preferred use of the disclosed invention is as a filter for the tea, instead of a tea strainer, such as the device disclosed in U.S. Pat. No. 489,468 to Dillwgham, incorporated herein by reference in its entirety, which is used to retain and submerge tea in water for the purpose of steeping. The disclosed invention allows the tea to be widely dispersed throughout the liquid, increasing the efficiency of the infusion process.

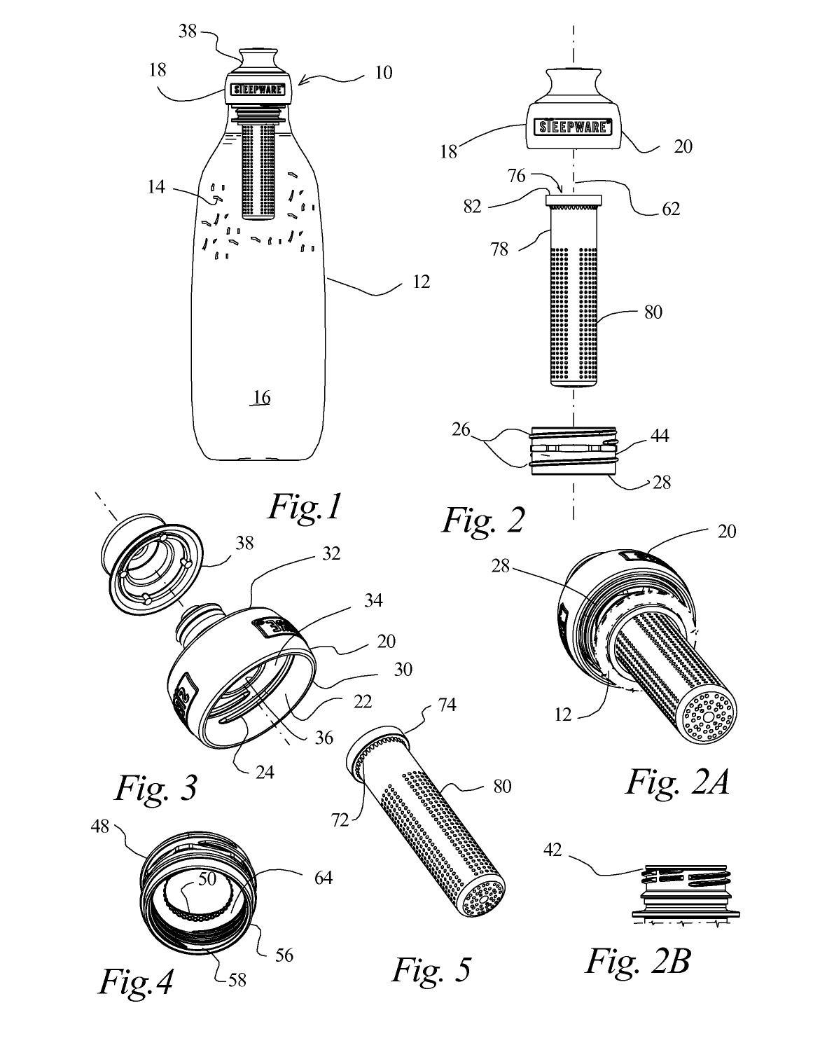

Turning now to FIGS. 2-5 it will be understood that the disclosed invention will include a cap 18 with a female coupler 20 that has a threaded concave section 22, which has internal threads 24. The internal threads 24 are adapted to cooperate with the external threads 26 that are found in a reversible adapter 28 that is used with the disclosed invention. The concave section 22 of the cap 18 has an inlet 30 and a top portion 32. The top portion 32 has a wall 34 that extends across the top portion and includes a hole 36 or aperture that leads to a telescopic valve 38. The telescopic valve 38 is preferably of the type that is used to create what is generally referred to as a “sports cap”, which includes a nipple 40 that can be extended telescopically to allow flow through the cap. This type of valve is well known, and is discussed in U.S. Pat. No. 2,998,902 to Thomas et al., which is incorporated herein by reference in its entirety.

While numerous manufacturers use the “sports cap” design in thin-walled water bottles, different manufacturers may use different threads or slightly different bottle mouth diameters. For example FIG. 2B illustrates the use of a bottle mouth 40 that has fine helical threads 42 that are made using processes such as the process described in U.S. Pat. No. 5,906,787 to Plester, incorporated herein by reference in its entirety. The disclosed invention uses the reversible adapter ring 28 to accommodate bottles with different pitch of threads or coarser threads along the mouth 40 of the bottle 12. As illustrated in FIG. 2A, the reversible adapter ring 28 fits within the female coupler 20, and the mouth 40 of the bottle 12 will be accepted by the internal threads 44 of the adapter ring 28.

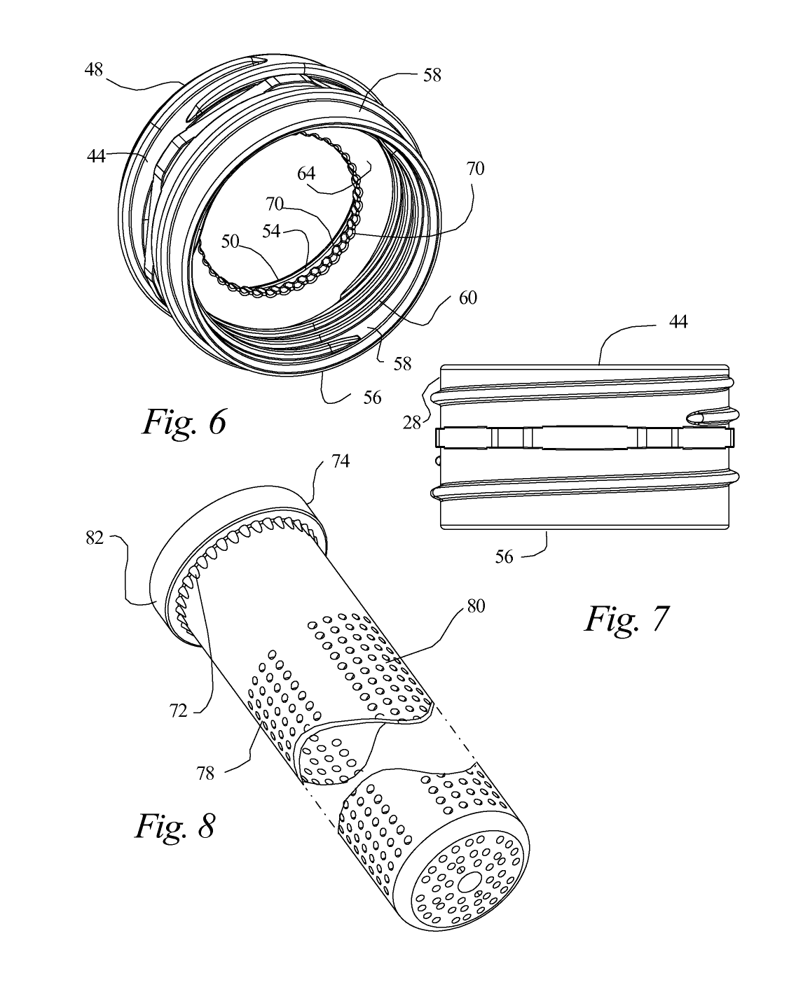

Thus, referring to FIGS. 2, 2A, 2B and 3-7 it will be understood that a preferred example of the adapter ring 28 will include an external surface 44 with external helical threads 26 that mate with the internal threads 24 of the female coupler 20. Importantly, FIGS. 2, 4, 6, and 7 show that in a preferred example of the invention the adapter ring 28 will include a first end 48 with a first internal surface 50 of a first diameter. Also, that the first internal surface 50 will include a first set of internal threads 54 of a first pitch. Additionally, the adapter ring 28 will also have a second end 56, which will include a second internal surface 58 that has having a second set of internal threads of a second pitch 60, The first internal surface 52 and the second internal surface 58 extending along an axis 62. Also, these figures illustrate that the first internal surface 52 is separated from the second internal surface 58 by an internal divider wall 64. The internal divider wall 64 will include an aperture 66 that extends between the first internal surface 52 and the second internal surface 58, FIG. 6 illustrates that the aperture of the internal divider wall will be bounded by an internal perimeter 68 with a plurality of internal retraining teeth or recessed areas 70 extending from the central aperture. In the illustrated example, the retaining recessed areas 70 are positioned along the perimeter 68, facing both the first internal surface 50 and the second internal surface 58 of the reversible adapter 28.

Referring now to FIG. 8, it will be understood that the recessed areas or teeth 70 will cooperate with mating ribs 72 along an flange 74 that is found at the inlet 76 of the filter portion 78 used with the disclosed invention. Preferably, the filter portion 78 will be made of a molded mesh portion 80 that is of integral one-piece construction with the flange 74. Also shown in FIG. 8 is that the ribs 72 will extend between the filter portion 78 and the flange 74. The opposing face 82 of the flange 74 will preferably be flat, as illustrated in FIG. 2.

Thus, according to the illustrated preferred embodiments in FIGS. 2 and 8, the filter portion 78, or filter element, will include an inlet with an inlet flange 74 and a mesh section 80 that extends from the inlet flange 74. The rib or ribs 72 of the filter portion 78 will cooperate with the teeth 70 of the reversible adapter ring 28, so that the reversible adapter ring 28 can be threaded into the female coupler 20 in either direction and capture the inlet flange 74 between the wall 34 of the top portion 32 of the female coupler 20 and the internal divider wall 64. This will cause the rib or ribs 72 to engages the teeth 70 on the internal divider wall 64, and thus allow use of the external helical threads 26 of the reversible adapter 28 to mate with the internal threads 24 of the female coupler 20, and thus compress the flange 74 against the cap 18 while allowing the internal threads of the first end 48 or the second end 56 of the reversible adapter ring 28 to engage the threaded neck of the bottle 12.

Thus it can be appreciated that the above-described embodiments are illustrative of just a few of the numerous variations of arrangements of the disclosed elements used to carry out the disclosed invention. Moreover, while the invention has been particularly shown, described and illustrated in detail with reference to preferred embodiments and modifications thereof, it should be understood that the foregoing and other modifications are exemplary only, and that equivalent changes in form and detail may be made without departing from the true spirit and scope of the invention as claimed, except as precluded by the prior art.

What is claimed is:

1. A portable filter cap adapted to attach to various sized threaded necks of bottles, the portable filter cap comprising:
a cap having a female coupler having a concave section with an inlet and top portion, the female coupler having internal threads between the inlet and the top portion, the female coupler having a top wall that extends across the top portion, the top wall having a hole approximately at its center;
a reversible adapter ring having an external surface having external helical threads that mate with the internal threads of the female coupler of the cap, the reversible adapter ring further having a first end having a first internal surface having a first set of internal threads of a first diameter and of a first pitch, and a second end a second internal surface having a second set of internal threads of a first diameter and of a second pitch, the first internal surface being separated from the second internal surface by an internal divider wall, the internal divider wall having a central aperture with a plurality of retraining teeth extending from the central aperture; and
a filter element having an inlet with an inlet flange an a mesh section extending from the inlet flange, the inlet flange having at least one rib positioned between the inlet flange and the mesh section, the rib being adapted for engaging the retaining teeth of the adapter ring, so that the reversible coupler can be threaded into the female coupler in one direction to capture the inlet flange between the top wall of the female section and the internal divider wall, so that the rib engages the teeth on the internal divider wall to allow use of the external helical threads that mate with the internal threads of the female coupler of the cap to compress the flange against the cap while allowing the internal threads of the first end or the second end of the reversible adapter ring to engage the threaded neck of the bottle

2. A filter and cap for use on refillable or disposable water bottles, the filter and cap comprising:
a cap with a female coupler having a threaded concave section with an inlet and top portion, the top portion including a wall that extends across the top portion and include a hole or aperture that leads to a telescopic valve;
a reversible adapter ring that fits within the female coupler, the adapter ring includes an external surface with external helical threads that mate with the internal threads of the female coupler of the cap, the reversible adapter ring also having:
a first end with a first internal surface of a first diameter, the first internal surface including a first set of internal threads of a first pitch; and
a second end having a second internal surface having a second set of internal threads of a second pitch, the first internal surface and the second internal surface extending along an axis, and the first internal surface being separated from the second internal surface by an internal divider wall having an aperture that extends the first internal surface being separated from the second internal surface, the aperture of the internal divider wall having an internal perimeter with a plurality of internal retraining teeth extending from the central aperture;
the aperture of the internal divider wall of the central aperture reversible adapter ring accepting a filter element there through, the filter element having an inlet with an inlet flange and a mesh section extending from the inlet flange, the inlet flange having at least one rib positioned between the inlet flange and the mesh section, the rib being adapted for engaging the teeth of the adapter ring, so that the reversible coupler can be threaded into the female coupler in either direction and capture the inlet flange between the top wall of the female section and the internal divider wall, so that the rib engages the teeth on the internal divider wall to allow use of the external helical threads that mate with the internal threads of the female coupler of the cap to compress the flange against the cap while allowing the internal threads of the first end or the second end of the reversible adapter ring to engage the threaded neck of the bottle.
